(19) United States
(12) Patent Application Publication
(10) Pub. No.: US 2013/0003797 A1
(43) Pub. Date: Jan. 3, 2013

(54) UNIVERSAL MODEM SYSTEM AND THE MANUFACTURING METHOD THEREOF

(75) Inventors: Chia-Pin CHEN, Hsinchu (TW); Tai-Yuan Cheng, Taoyuan (TW); Chang-Lung Hsiao, Hsinchu (TW); Ren-Jr Chen, Hsinchu (TW)

(73) Assignee: Industrial Technology Research Institute, Hsinchu (TW)

(21) Appl. No.: 13/494,355

(22) Filed: Jun. 12, 2012

Related U.S. Application Data
(60) Provisional application No. 61/503,037, filed on Jun. 30, 2011.
(60) Provisional application No. 61/515,596, filed on Aug. 5, 2011.

(51) Int. Cl. H04B 1/38

(52) U.S. Cl. 375/222

(57) ABSTRACT

According to one exemplary embodiment of a universal modem system, multiple digital signal processors (DSPs) are configured to perform at least one streaming-based task, or at least one block-based task, or both of the tasks. At least one concatenate memory is configured to store data for the at least one streaming-based task At least one concatenate bus connects at least one concatenate memory and the plurality of DSPs serially for performing the at least one streaming-based task. At least one concatenate memory is configured to store the data for the at least one streaming-based task. At least one public bus connects the plurality of DSPs and the at least one shared memory for performing the at least one block-based tasks.

### CROSS-REFERENCE TO RELATED APPLICATION

The present application is based on, and claims priorities from, U.S. Provisional Application No. 61/503,037, filed Jun. 30, 2011, and U.S. Provisional Application No. 61/515,596, filed Aug. 5, 2011, the disclosure of which is hereby incorporated by reference herein in its entirety.

### TECHNICAL FIELD

The present disclosure generally relates to a universal modem system and the manufacturing method thereof.

### BACKGROUND

There are wide ranges of radio applications like wireless local area network (WLAN), mobile phone, digital video broadcasting and satellite communication, etc. The basic baseband functions are almost the same, such as modulation/demodulation, equalization, correlation and coding. Software-Defined Radio (SDR) technology enables implementation of radio functions as software modules running on a generic hardware platform. Different radio applications may co-exist in the same equipment, such as by selecting appropriate Software (SW) modules. FIG. 1 shows a schematic view of an exemplary SDR cooperating with Hardware (HW) accelerators, for dual radio applications. The upgrade of specs may be easily achieved by updating the software load. Thus SDR may offer significant advantages for its high flexibility, short design cycle and even high performance when cooperating with accelerating coprocessors implemented by hardware accelerators with or without programmable functions.

There are various kinds of modem specs, and the elementary operations are almost the same. Typically, the inner elementary operations may include, but not be limited to, Fast Fourier Transform (FFT), convolution, correlation, vector multiplication, etc., and the outer elementary operations may include, but not be limited to, interleaving, scrambling error correction, etc. Many applications of modem systems may have different specs and high product values. One exemplary multi-standards modem with hybrid single Digital Signal Processor (DSP) and HW accelerator may use an on-chip network, switches and shared memories divided into a plurality of main banks. For high throughput applications, multi-cores architecture is greatly used in the platform for running the software functions. In some technologies using the multi-cores architecture, the data transmissions inter DSPs are usually through a shared bus with an arbitrator or a network with routers and/or switches, or a shred cache. The data transmitted among DSPs is usually stored in a shared memory hooked on the shared bus or the network and visible by all DSPs, as shown in FIG. 2.

Many patent documents or literatures disclosed technologies for implementations of SDR. As seen in FIG. 3 of an exemplary architecture of SDR using multi-core processor 302. In the SDR platform and system 300 of FIG. 3, a radio control board 316 passes a plurality of digital samples 322 between a shared memory 314 of a computing device and RF transceiver 318 coupled to a system bus 312 of the computing device. A multi-core processor 302 is in communication via a bus interface with the system bus 312, and thereby to the shared memory 314. Due to the frequently accesses of the shared memory, high bandwidth of the shared memory is required. Since all DSPs access the shared memory via the same bus, bus arbitration or routing design is required.

Another patent document disclosed technology of an exemplary implementation of a programmable baseband processor (PBBP) of a multi-mode wireless communication device, as seen in FIG. 4. The PBBP 400 includes a clustered single instruction multiple data (SIMD) microarchitecture, and configures a complex computing unit 490 to execute SIMD instructions with accelerators coupled complex arithmetic logic unit (ALU) paths, each further including short multiplier/accumulator using two's complement. A network interconnect 450 with dynamic routing is coupled between a processor core 446 and the complex computing unit 490, and each of the shared data memories and the accelerators.

The multi-cores system may be divided into categories of homogenous system and heterogeneous system. The homogenous system uses the same DSPs. Because the kernel functions may be quite different, the DSPs may have a large instruction set to support all the functions. Thus the area and the performance requirement of the DSPs in the homogeneous system are very high. The heterogeneous system uses different specific DSPs for executing the different kernel functions. Thus the area and the performance requirements of each DSP are quite low compared to that in the homogeneous system. However, each DSP for the heterogeneous system requires specific design.

Various solutions for modem systems utilizing SDR techniques have been suggested. In general, the data transmissions among DSPs of these solutions are through the shared bus with arbitrator, network with switch/router, or shared cache. A large degree of reducing the loading of the shared bus or the network and decreasing the probability of data collision on the bus may be needed for utilizing a multi-cores SDR technique in the universal modem system.

### SUMMARY

The exemplary embodiments of the disclosure may provide a universal modem system and the manufacturing method thereof.

One exemplary embodiment relates to a universal modem system. The system may comprise a plurality of digital signal processors (DSPs), at least one concatenate bus, at least one concatenate memory, at least one public bus and at least one shared memory. The plurality of DSPs are configured to perform at least one streaming-based task, or at least one block-based task, or both of the tasks. The least one concatenate bus connects the at least one concatenate memory and the plurality of DSPs serially for performing the at least one streaming-based task. The at least one concatenate memory is configured to store the data for the at least one streaming-based task. The at least one public bus connect the plurality of DSPs and the at least one shared memory for performing the at least one block-based tasks.

Another exemplary embodiment relates to a method for manufacturing a universal modem system. The method may comprise: configuring a plurality of DSPs to perform at least one streaming-based task, or at least one block-based task, or both of the tasks; connecting at least one concatenate bus to at least one concatenate memory and the plurality of DSPs serially for performing the at least one streaming-based task; configuring at least one concatenate memory to store the data for the at least one streaming-based task; and connecting at least one public bus to the plurality of DSPs and at least one shared memory for performing the at least one block-based tasks.

### BRIEF DESCRIPTION OF THE DRAWINGS

FIG. 1 shows a schematic view of an exemplary SDR cooperating with HW accelerators, for dual radio applications.

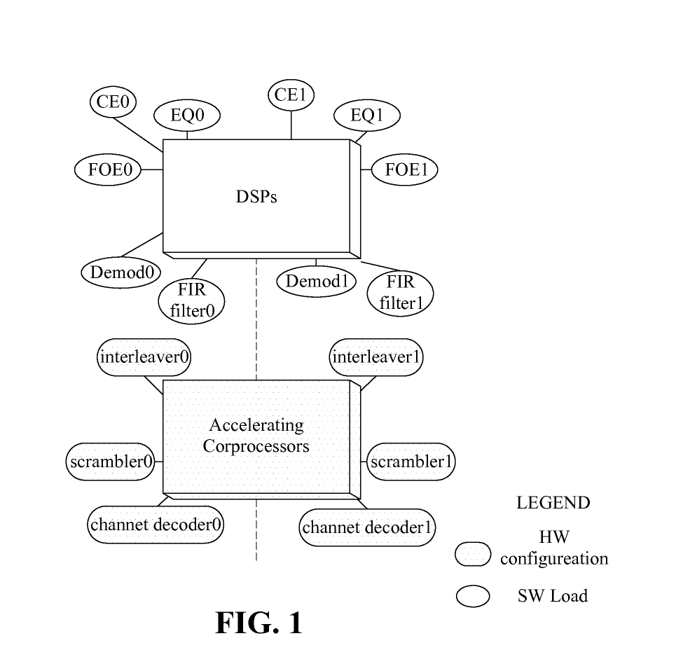

FIG. 2 shows a schematic view of an exemplary architecture for multi-cores architecture used in the platform for running the software functions.

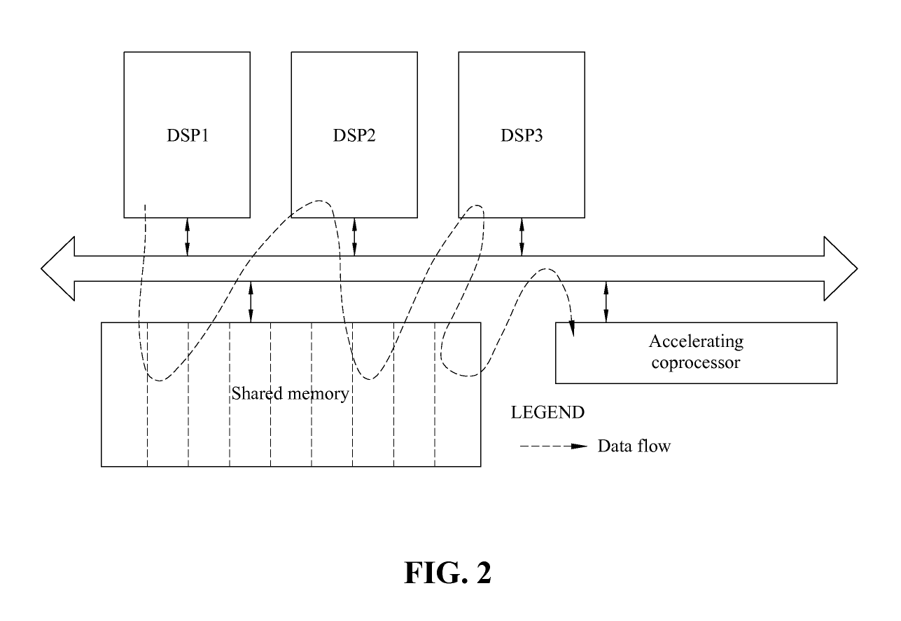

FIG. 3 shows an exemplary architecture of SDR using multi-core processor.

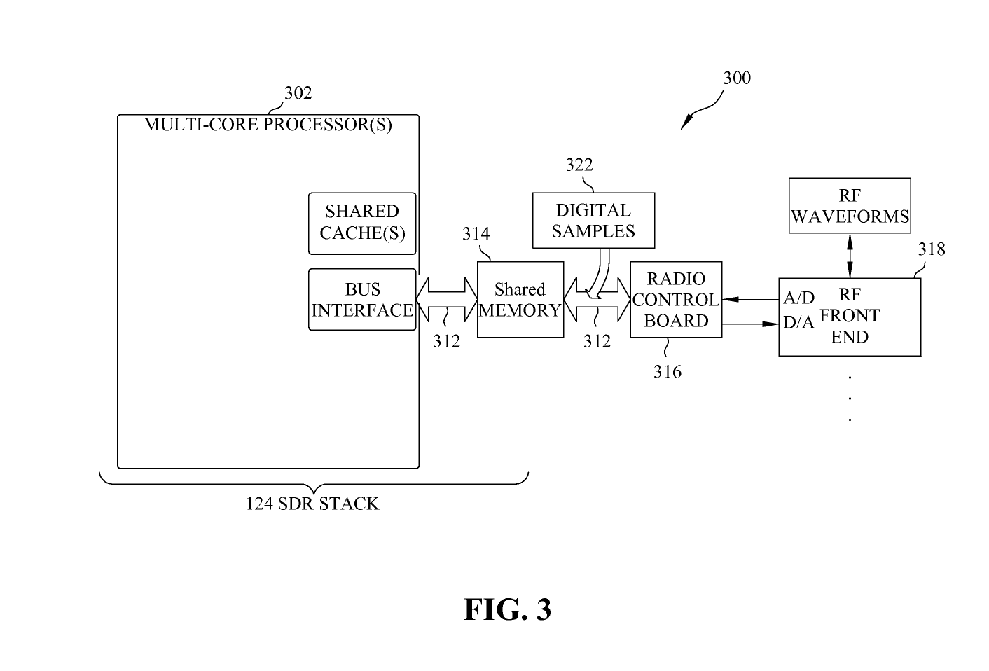

FIG. 4 shows a schematic view of an exemplary programmable baseband processor (PBBP) of a multi-mode wireless communication device.

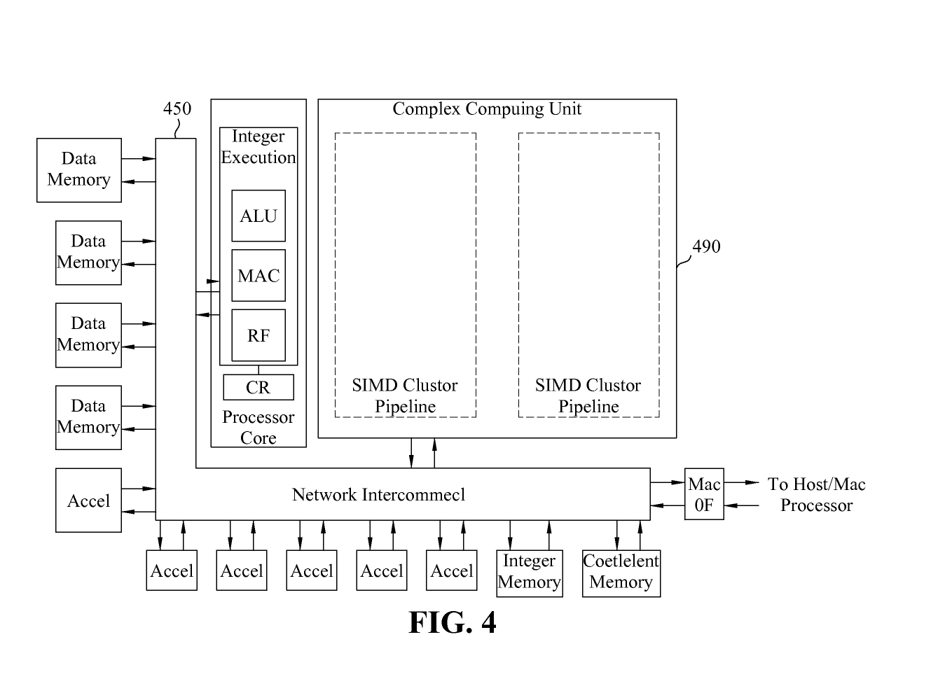

FIG. 5 shows a schematic architecture of a universal modem system, according to an exemplary embodiment.

FIG. 6 shows a DVB-T receiver using the architecture of FIG. 5, according to an exemplary embodiment.

FIGS. 7A-7C show different ways to configure a typical concatenate memory, according to exemplary embodiments.

FIG. 8 shows a DVB-T receiver with a broadcasting path via the public bus, by using the architecture of FIG. 5, according to an exemplary embodiment.

FIG. 9 shows a DVB-T receiver with a broadcasting path via the CC bus, by using the architecture of FIG. 5, according to an exemplary embodiment.

FIG. 10 shows a schematic architecture of a universal modem system, according to another exemplary embodiment.

FIG. 11 shows a table of exemplary algorithms for the carrier frequency synchronization block and the required coprocessors for hardware accelerating.

FIG. 12 shows a DVB-T receiver with selectable L1 Copros, according to an exemplary embodiment.

FIG. 13 shows a DVB-T receiver with selectable L1 Copros, by utilizing the architecture of FIG. 10, according to another exemplary embodiment.

FIG. 14 shows a command format, according to an exemplary embodiment.

FIG. 15 shows the protocol of the coprocessor interface in the FIG. 13, according to an exemplary embodiment.

FIG. 16 shows a schematic view of a switch mechanism, according to an exemplary embodiment.

FIG. 17 shows a manufacturing method for the universal modem system, according to an exemplary embodiment.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

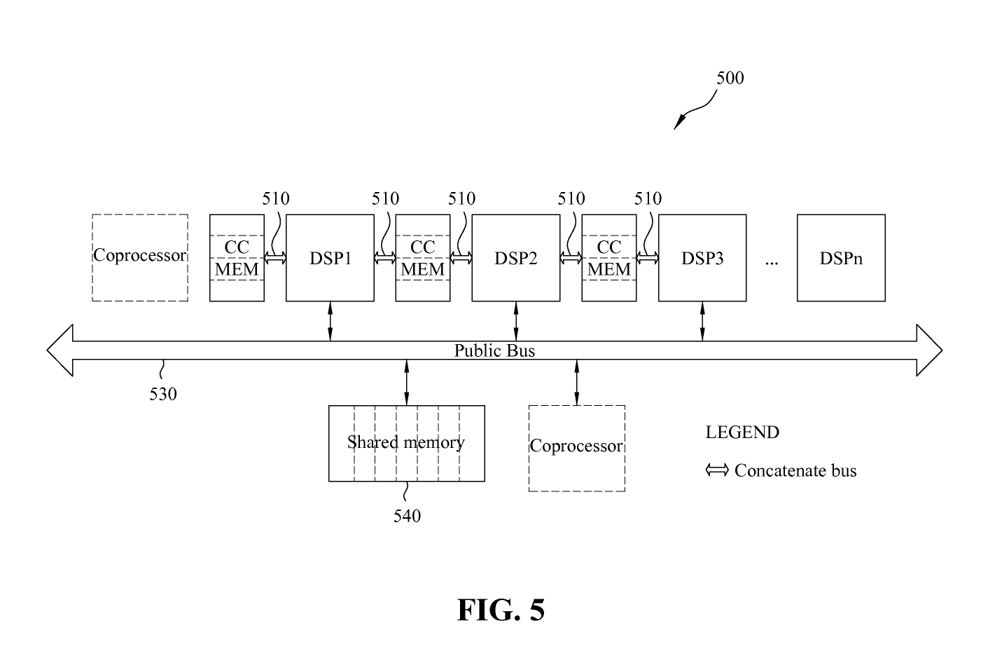

As seen in FIG. 5, one exemplary embodiment of a universal modem system is disclosed. The universal modem system 500 may comprise a plurality of digital signal processors denoted by DSP1˜DSPn, n≧2, at least one concatenate bus (CC bus) 510, at least one concatenate memory 520, at least one public bus 530 and at least one shared memory 540. The least one concatenate bus 510 connects the at least one concatenate memory 520 and the DSP1˜DSPn serially. The DSP1˜DSPn are configured to perform at least one streaming-based task, or at least one block-based task, or both of the tasks. The at least one streaming-based task is performed via the at least one concatenate bus 510, and the data for performing the streaming-based task is stored in the at least one concatenate memory (CC MEM) 520. The at least one public bus 530 connects the DSP1˜DSPn and the at least one shared memory 540 for performing the at least one block-based task, and the data such as a plurality of instructions for performing the at least one block-based task is stored in the at least one shared memory 540.

The at least one streaming-based task may include a plurality of streaming-based operations such as one or more symbol by symbol operations performed by at least one processing element coupled by the at least one CC bus 510, such as modulation, demodulation, channel estimation, equalization etc. The at least one streaming-based task may be performed by the processing elements coupled by the at least one concatenate bus 510. The at least one block-based tasks may include a plurality of block-based operations, such as broadcasting, one or more feedback operations, passing the data needed on one or more non-adjacent elements coupled by the at least one concatenate bus 510, or one or more operations to be performed after a block of data is ready. Processing the one or more block-based tasks may be started once the data in the shared memory is ready. In other words, the data processing inside the universal modem system may include streaming-based processing and block-based processing, but not limited to. The non-adjacent elements may be, but not limited to, DSPs executing the plurality of instructions or coprocessors performing one or more dedicate functions, etc.

Some operations in the radio functions may be more suitable for hardware implementation than software, such as division, sin, cosine, min, max, etc. When they are implemented by hardware, those operations may require only small area and/or short operating time. Thus, the DSPs in the embodiments of the universal modem system may co-operate with one or more coprocessors for executing different kernel functions, which may act as hardware accelerating devices. The coprocessors may share the at least one shared memory 540 with the DSP1˜DSPn. The coprocessors may be implemented by hardware accelerating devices with or without programmable functions. Some exemplary implementation may not include coprocessor(s) in the universal modem system. In other words, the coprocessors may or may not be included in the universal modem system. As seen in FIG. 5, the exemplary embodiment may reduce the loading of the shared bus or the network and decrease the probability of data collision on the bus. Thus, the complicated design of arbitrators or routers may be avoided in the universal modem system 500. The exemplary architecture of the system 500 also may ease the bandwidth requirement of the shared memory.

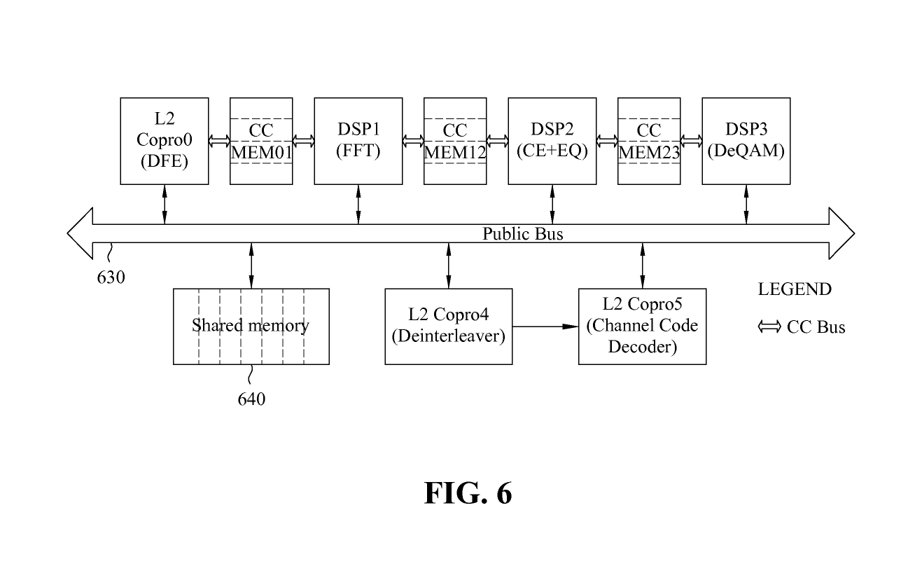

FIG. 6 shows an exemplary DVB-T receiver using the architecture of FIG. 5, according to an exemplary embodiment. In FIG. 6, the DVB-T receiver may have no feedback or broadcasting paths. The data pipelines on the concatenate bus describe as Digital Front End (DFE)→FFT→Channel Estimation (CE)+Equalization (EQ)→Demodulation Quadratic Amplitude Modulation (DeQAM). The DVB-T receiver 600 may comprise three DSPs, three concatenate memories (CC memories, say CC Mem01, CC Mem12, and CC Mem23), one shared memory, one concatenate bus (CC Bus) and one public bus 630. The first processing element (referred to the processing element at stage 0) on the CC Bus is a Coprocessor, say L2 Copro0, which is in charge of the function of DFE. The second processing element (referred to the processing element at stage 1) is a DSP, say DSP1, which performs the functions of FFT. The third and the forth processing elements (referred to the processing elements at stage 2 and stage 3, respectively) are DSPs, say DSP2 and DSP3, which are responsible for CE and EQ, and DeQAM respectively. Each processing element on the CC Bus is connected by the three CC memories. In the DVB-T receiver 600, the shared parts of the CC memories may be implemented with ping-pong buffers. The four processing elements on the CC bus, together with the three CC memories, perform the streaming-based operations required for the DVB-T receiver 600, and the data output from the last processing element on the CC Bus (i.e. DSP3 performs DeQAM) is collected in the shared memory 640 via the public bus 630 for the successive block-based operations.

The block-based operations in this exemplar include de-interleaving and channel code decoding, which are implemented by two Coprocessors, say L2 Copro4 and L2 Copro5 respectively. Once an Error-Correcting Code (ECC) block is collected in the shared memory, the deinterleaver and the channel code decoder may access the data via the public bus 630 and start their corresponding tasks to perform the decoding task. In the exemplar, two accesses are occurred on the public bus 630 for each ECC block. One access is from DeQAM to the shared memory 640, and the other access is from the shared memory 640 to the channel code decoder.

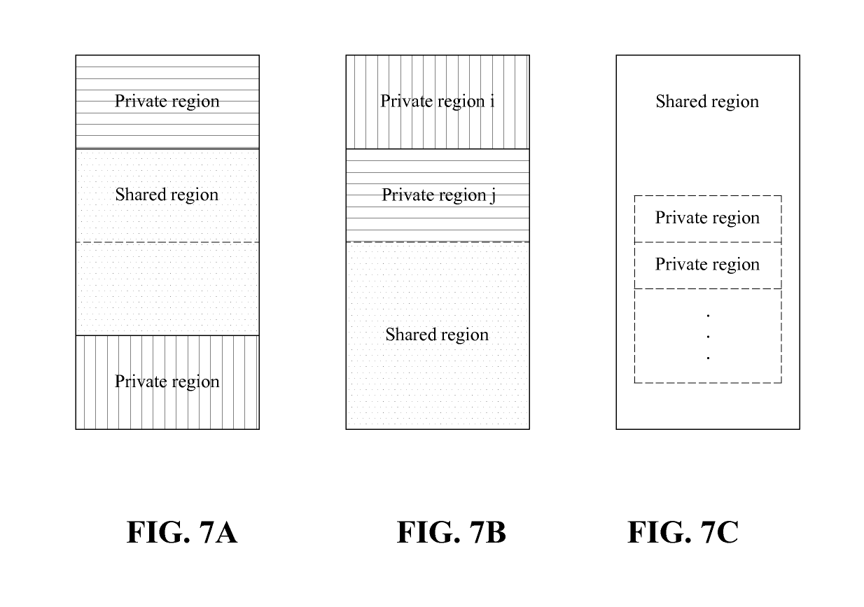

As seen in the exemplar of FIG. 6, the concatenate memory CC Memij is accessible by the L2 Copros or DSPs at stage i and stage j on the CC Bus. For example, the concatenate memory CC Mem01 is accessible by L2 Copro0 or DSP1 at stage 0 and stage 1 on the CC Bus, while the concatenate memory CC Mem23 is accessible by DSP2 or DSP3 at stage 2 and stage 3 on the CC Bus. In other words, concatenate memory CC Memij, j=i+1, is visible only by the processing element at stage i or the processing element at stage j on the CC Bus. There may be several ways to configure a typical concatenate memory CC Memij, j=i+1, as shown in FIG. 7A-FIG. 7C. In FIG. 7A, concatenate memory CC Memij is divided into three parts with a configurable memory size, wherein Private region i stores the data only processed by accelerating coprocessors or DSPs at stage i, Private region j stores the data only processed by accelerating coprocessors or DSPs at stage j, and Shared region ij stores the data which commutes between accelerating coprocessors or DSPs at stage i and stage j. The locations in concatenate memory CC Memij for private region i, private region j, and shared region ij are changeable, as shown in FIG. 7B. Concatenate memory CC Memij may also be configured as a shared region with one or more private regions therein or without any private region therein, as shown in FIG. 7C. The CC Mem mainly holds the data for the streaming-based operations and may be implemented by such as ping-pong buffer, ring buffer, first in first out (FIFO), etc.

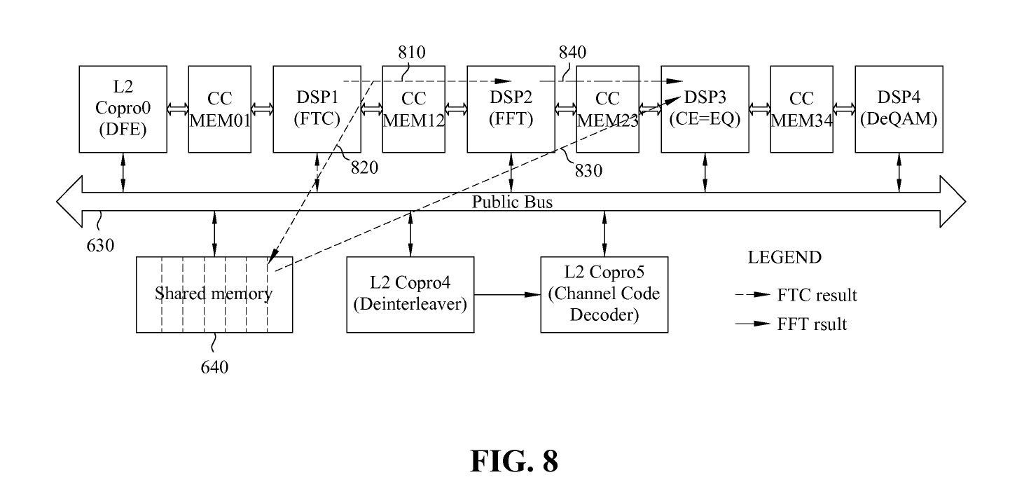

FIG. 8 shows a DVB-T receiver with a broadcasting path via the public bus, by using the architecture of FIG. 5, according to an exemplary embodiment. Compared to the exemplar of FIG. 6, one additional function FTC (Frequency Timing Correction) is introduced and performed by DSP1 in FIG. 8. In the exemplar of FIG. 8, the FTC-processed output must be broadcasted to both of DSP2 (perform FFT) and DSP3 (perform CE+EQ. The broadcast data goes through the public bus in the following schedule: (1) FTC output data is passed to FFT by CC Mem12 via CC Bus, as indicated by a reference 810, (2) FTC output data is put in the shared memory via the public bus, as indicated by a reference 820, (3) CE+EQ get the FTC output data from the shared memory via the public bus, as indicated by a reference 830, and (4) CE+EQ get the FFT output data from CC Mem23 via the CC Bus, as indicated by a reference 840. Accordingly, FFT (DSP2) may start to work once the FTC-processed data is received. Thus, if FFT is the performance bottleneck of the elements on the CC Bus, this processing schedule may minimize the processing latency.

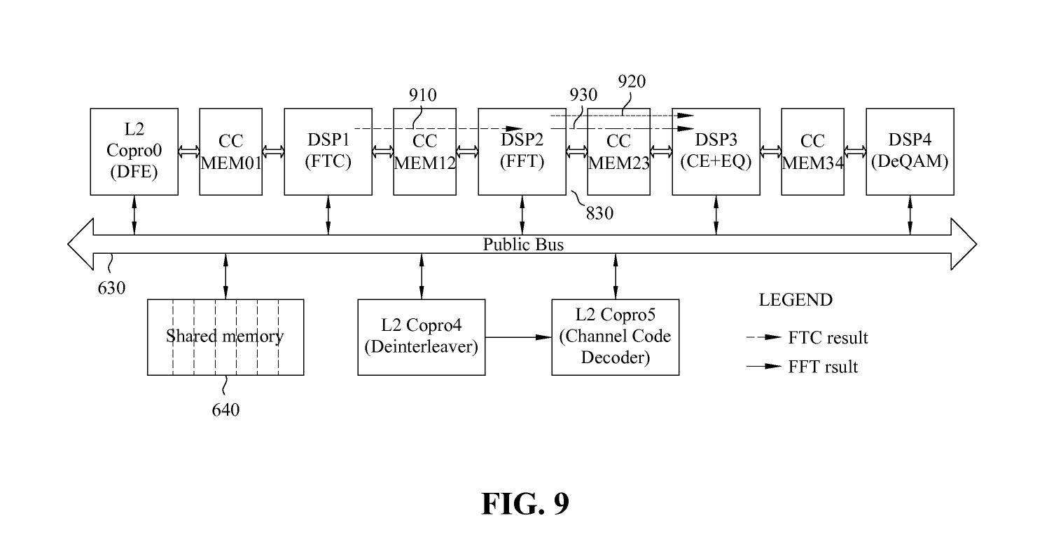

FIG. 9 also shows the exemplary DVB-T receiver with a broadcasting path, and the FTC-processed output must be broadcasted to both of the FFT and CE+EQ DSPs. Different from FIG. 8, the broadcast data in FIG. 9 goes through the CC Bus in the following schedule: (1) FTC output data is passed to FFT by CC Mem12 via CC Bus, as indicated by a reference 910, (2) FTC output data is passed from FFT to CE+EQ by CC Mem23 via CC Bus, as indicated by a reference 920, and (3) CE+EQ gets the FFT output data from CC Mem23 via the CC Bus, as indicated by a reference 930. As seen in FIG. 9, there is no frequently access of the public bus and the shared memory. Therefore, the bandwidth requirement of the public bus and the shared memory may be reduced.

From the descriptions on FIG. 8 and FIG. 9, one may see that the usage of the public bus may be adjusted by simply applying different software codes executed on the DSPs. Thus the balance between the bandwidth requirement of the public bus and shared memory, and the pipeline latency of the CC Bus are achieved without any modifications on the HW system architecture.

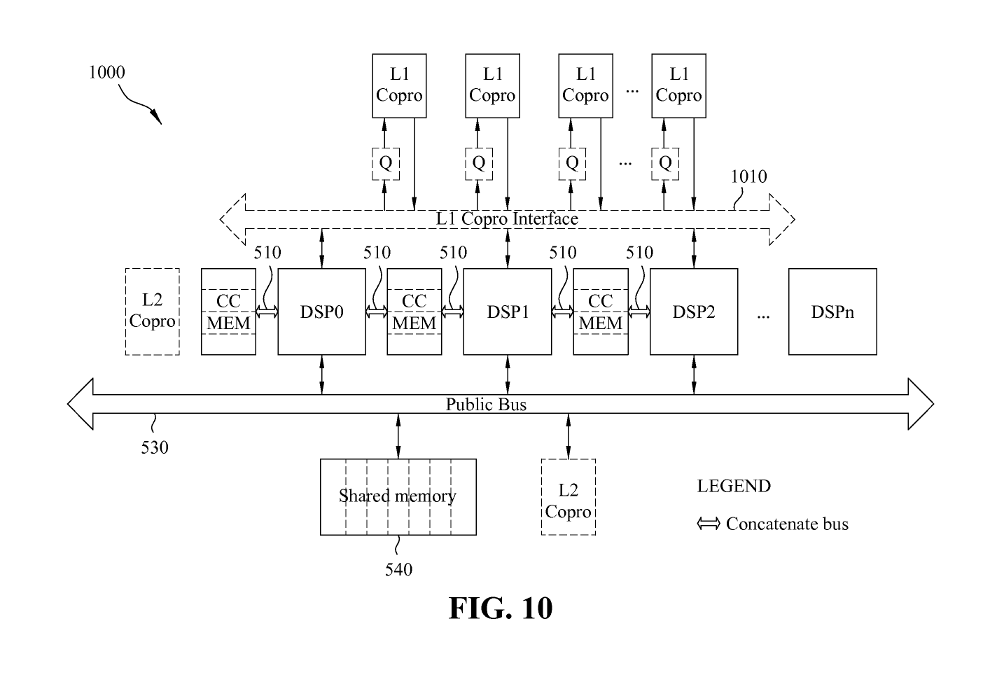

As mentioned earlier, the universal modem system of FIG. 5 may further comprise at least one coprocessors implemented by at least one hardware accelerating device with or without one or more programmable functions. A coprocessor in the system 500 is referred to an L1 Copro if the coprocessor is activated by at least one DSP and may access at least one CC Mem 520 directly. Different DSPs in the system 500 may use the same or different L1 Copros, or even no L1 Copros. As seen in the exemplary embodiment of a universal modem system 1000 of FIG. 10, the universal modem system 1000 includes the architecture of universal modem system 500, and further includes one or more L1 Copros. The one or more L1 Copros may be in charge of one or more accelerating functions required by DSP1˜DSPn, and activated by at least one DSP of the DSP1˜DSPn such as through at least one command issued by the at least one DSP to the one or more L1 Copros via an L1 Copro interface 1010. The at least one command may be included in at least one command queue Q, and the at least one command queue may be included in the Copro interface 1010 or the one or more L1 Copros, or coupled with the one or more L1 Copros. Or each of the at least one DSP may directly issue a command without utilizing any command queue or the L1 Copro interface 1010. If there is no command queue, the DSP which wants to use a busy L1 Copro will polling the status of the L1 copro until it is free.

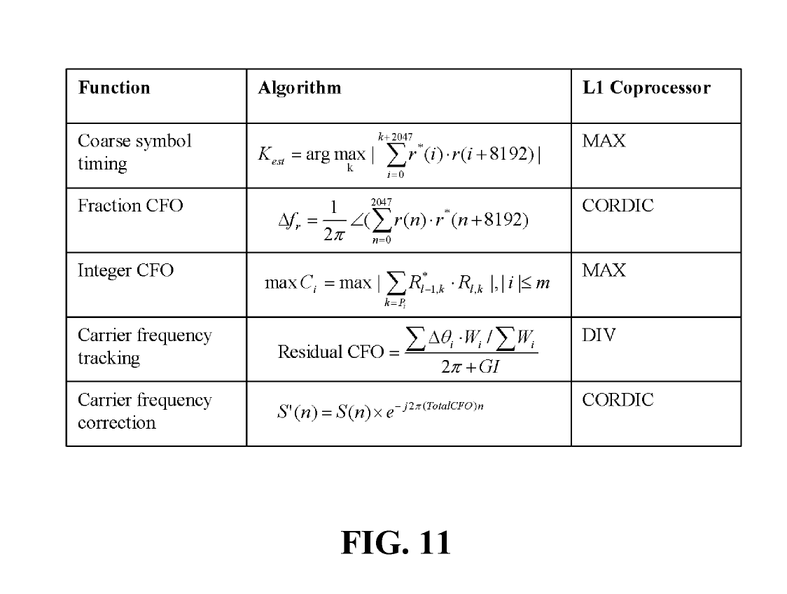

Some operations for modem systems may not be suitable for implemented by DSP instructions. Some operations may be specific and only needed by a DSP at a specific stage. For hardware accelerating these operations, it may use the L1 Copros that are activated and controlled by the DSPs in a modem system. FIG. 11 shows a table of exemplary algorithms for the carrier frequency synchronization block and the required coprocessors for hardware accelerating. As seen in FIG. 11, there are four kinds of L1 coprocessor, i.e. MAX, MIN, CORDIC and DIV. The L1 coprocessor MAX finds the maximum among the input data and returns the maximal value and a corresponding index of the maximum. Similarly, the L1 coprocessor MIN finds the minimum among the input data and returns the minimal value and a corresponding index of the minimum. The L1 coprocessor CORDIC (COordinate Rotation Digital Computer) accelerates the calculation of hyperbolic and trigonometric functions. The L1 coprocessor DIV accelerates the division of the inputs and returns the quotient and remainder.

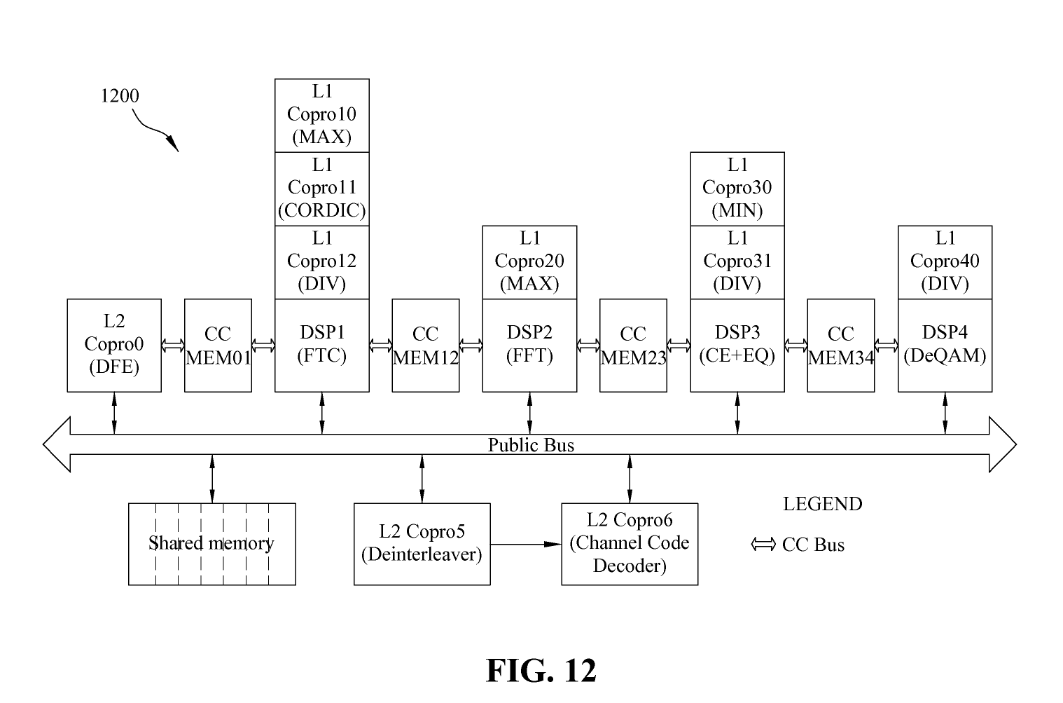

FIG. 12 shows a DVB-T receiver with selectable L1 Copros, according to one exemplary embodiment. As seen in FIG. 12, The DVB-T receiver 1200 with four kinds of L1 Copros, i.e. MAX, MIN, CORDIC and DIV. These L1 Copros are activated by at least one DSP of DSP1˜DSP4. Different DSPs may have the same or different L1 Copros, or even no L1 Copros, according to the functionalities which shall be accelerated. In this embodiment, DSP1 has one L1 coprocessor MAX, one L1 coprocessor CORDIC, and one L1 coprocessor DIV, and the three L1 Copros are labeled by L1 Copro10, L1 Copro11, L1 Copro12, respectively. DSP2 has one L1 coprocessor MAX labeled by L1 Copro20. DSP3 has one L1 coprocessor MIN and one L1 coprocessor DIV, and the two L1 coprocessors are labeled by L1 Copro30 and L1 Crpro31, respectively. DSP4 has one L1 coprocessor DIV labeled by L1 Copro40. With the existence of these L1 Copros, the performance of the system can be enhanced for high throughput applications. As shown in FIG. 12, different DSPs may execute different kernels of the modem system and require same or different coprocessors. Take the coprocessor DIV, which accelerates the division operation and used by DSP1, DSP3 and DSP4, as an example Since each DSP may have its own DIV coprocessor and all DIV coprocessors may not be activated at the same time, the L1 Copros may be shared for reducing the chip area.

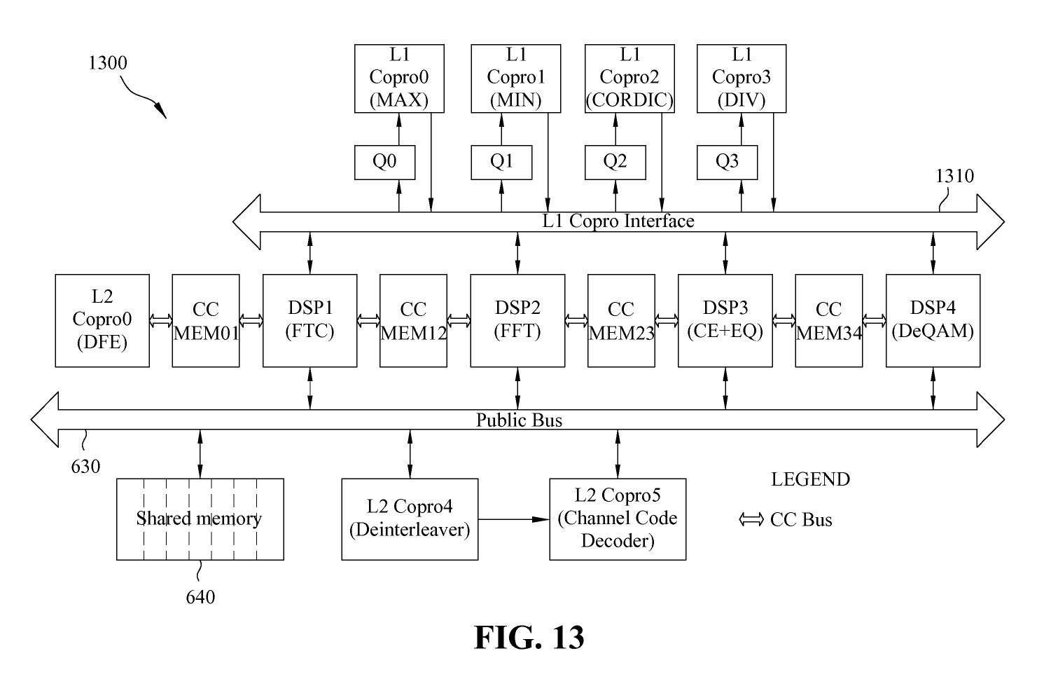

FIG. 13 shows a DVB-T receiver with selectable L1 Copros, by utilizing the architecture of FIG. 10, according to another exemplary embodiment. In this exemplary embodiment, the DVB-T receiver 1300 comprises four DSPs labeled by DSP1˜DSP4, four L1 Copros labeled by Copro0˜Copro3 being in charge of four accelerating functions of MAX, MIN, CORDIC and DIV, respectively, four command queues labeled by Q0˜Q3, and one coprocessor interface 1310. Each L1 Copro is coupled with an individual command queue. The system in this embodiment may be used to perform the chip-rate and symbol-rate processing in the OFDM-based receiver. Each L1 Copro has a coprocessor ID and each DSP has a DSP ID. Each DSP is in charge of several kernel functions of the modem system. All L1 Copros are activated by the commands issued by DSPs and shared among all DSPs via the coprocessor interface 1310.

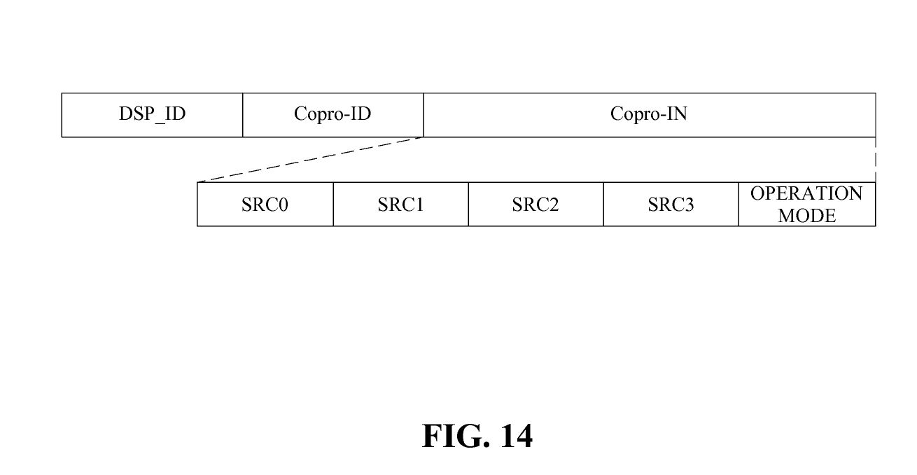

When a DSP needs to utilize an L1 coprocessor, it may issues a command to the coprocessor interface 1310. FIG. 14 shows a command format, according to an exemplary embodiment. As seen in FIG. 14, the command format may comprise, but not limit to, three fields of DSP_ID, Copro_ID and Copro_IN. The DSP_ID field specifies which DSP issues the command. The Copro_ID (i.e. coprocessor identifier) field specifies which coprocessor is needed. The Copro_IN field contains the input required for the needed coprocessor, such as the input data values SRC0˜SRC3, input data addresses, or the operation mode. Since all coprocessors are shared, there must be some opportunities that while one coprocessor is processing a command from a DSP, the other DSP issues a command to use the same coprocessor. Therefore, each coprocessor may be configured to couple to a command queue for buffering the incoming commands while the coprocessor is occupied.

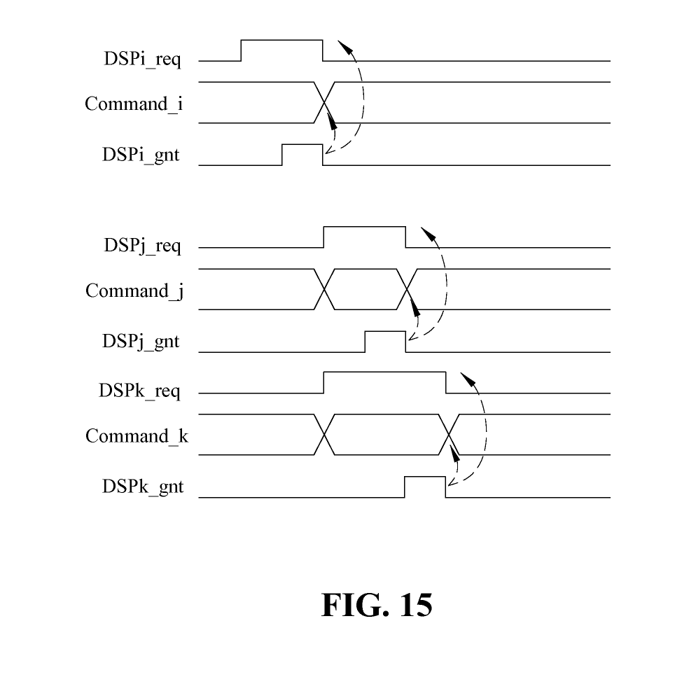

FIG. 15 shows the coprocessor interface protocol in the FIG. 13, according to an exemplary embodiment. In FIG. 15, assume that a DSP, say DSPi, wants to use a coprocessor. DSPi asserts a signal DSPi_req to inform the coprocessor interface. A corresponding command (command_i) is also issued to the coprocessor interface by the DSP. When there is no other DSPs requesting the coprocessors at that time is confirmed, the coprocessor interface will return a grant DSPi_gnt to DSPi and patch the command (command_i) to a command queue of a corresponding coprocessor according to a Copro_ID in the command (command_i). After receiving DSPi_gnt, DSPi de-asserts DSPi_req. The coprocessor with the Copro_ID processes the commands (command_i) in its command queue and returns the results to DSPi according to a DSP_ID in the command (command_i) after it finishes the command (command_i) issued by DSPi.

In other words, the universal modem system according to the exemplary embodiments may includes a coprocessor interface protocol between the at least one coprocessor and the at least one DSP, and the coprocessor interface protocol may include at least one coprocessor request and at least one command from the at least one DSP, at least one coprocessor grant from a coprocessor interface, and at least one arbitration scheme in the coprocessor interface. The at least one DSP may assert the coprocessor request, and hold the coprocessor request and the command until one of the at least one coprocessor request is granted by the coprocessor interface. The coprocessor interface may dispatch the command of the granted DSP to a command queue of a corresponding coprocessor according to a Copro_ID.

In some cases, there might be more than one DSPs acquire the coprocessors at the same time. Assume that there are two DSPs, say DSPj and DSPk, wanting to utilize the coprocessors with Copor_IDj and Copor_IDk, respectively. Here, Copor_IDj and Copor_IDk may be the same or different. As seen in FIG. 15, signal DSPj_req and signal DSPk_req are asserted at the same time. The coprocessor interface grants one request, say DSPj, according to an arbitration scheme. The arbitration scheme may be, but not limited to, round Robin, weighted arbitration or prioritized arbitration etc. The coprocessor interface sends the grant DSPj_gnt to DSPj and patches the command of DSPj to the command queue of the coprocessor with Copro IDj. After receiving DSPj_gnt, DSPj de-asserts DSPj_req. The un-granted DSPk holds its request DSPk_req and the command remains unchanged until DSPk is granted by the coprocessor interface. In other embodiment, the coprocessor interface may generate only one grant signal which contains the granted DSP_ID, and each DSP decodes the individual grant information by itself.

The waiting time due to the arbitration and the execution of command queues may affect the system performance. In this disclosure, a switch mechanism which helps DSPs to decide whether to run a software function or to acquire a coprocessor is introduced. In an exemplary embodiment of the switch mechanism, each of coprocessors may calculate its own wait cycle, and decide a switch flag by comparing the wait cycle with individual threshold value. An instruction may be used to examine the registers coupled to the switch flags of coprocessors for deciding whether or not to use a coprocessor by a DSP. In other words, whether or not a DSP acquires a coprocessor may depend on a switch flag, a wait cycle and an individual threshold of the coprocessor.

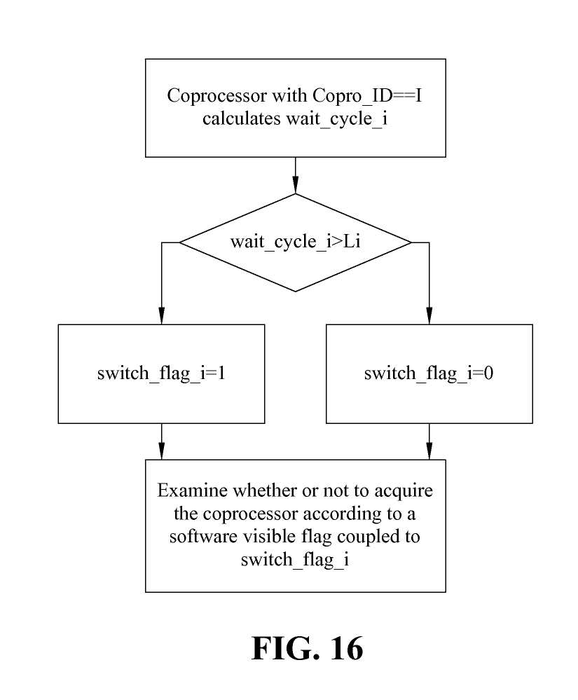

Consider an L1 coprocessor with Copro_ID==i in FIG. 16. The L1 coprocessor calculates its own wait cycle. Suppose Mi cycles are taken for the coprocessor to finish a command in a command queue, and Ni cycles are taken for a DSP to perform the same function as the coprocessor does by executing software instructions. Assume that there are Qi commands in the command queue of the coprocessor waiting for processing, M0i remaining cycles for the currently processing command, and R requests in the coprocessor interface. The wait cycle wait_cycle_i of the coprocessor with Copro_ID==i may be estimated by the equation of wait_cycle_i=Qi*Mi+M0i+R. When the wait cycle wait_cycle_i is greater than an individual threshold value Li, it is more efficient for a DSP to execute software codes than to acquire the coprocessor with Copro_ID==i. The coprocessor with Copro_ID==i or the DSP may check if the wait cycle wait_cycle_i is greater than a threshold value Li. In this embodiment, Li may be set to Ni. Thus the coprocessor sets its switch flag (switch_flag_i) once wait_cycle_i exceeds the threshold Li.

For each DSP which may use the coprocessor, a software visible register is coupled to the switch_flag_i of the coprocessor with Copro_ID==i. The register coupled to switch_flag_i may be configured for helping the DSP to decide whether the usage of the coprocessor may accelerate the operations. In the exemplary embodiment of FIG.16, a branch checking is used to examine the register coupled to switch_flag_i before acquiring the coprocessor. When the register shows that switch_flag_i is set (for example, switch_flag_i=1), the branch jumps to a series of software codes which perform the same function as the coprocessor does; otherwise, the branch jumps to an instruction to let the DSP issue a command to use the coprocessor. This switch mechanism may apply to all coprocessors and all DSPs in the system.

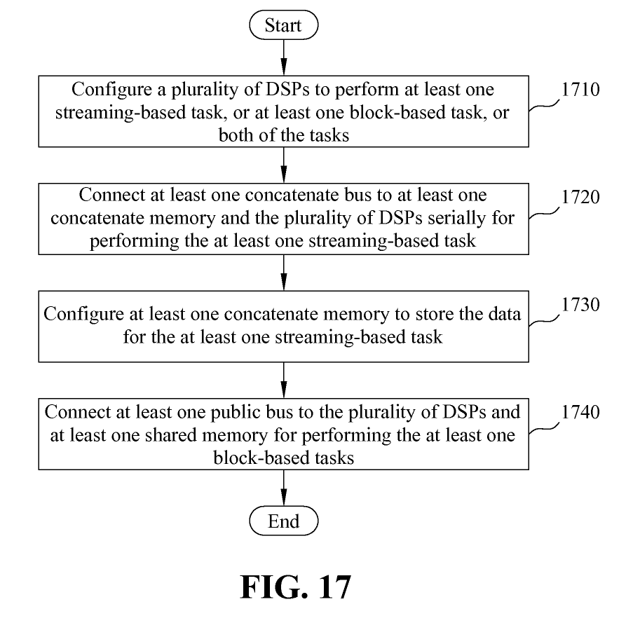

Therefore, the above exemplary architecture of the universal modem system utilizing multi-cores SDR technique reduces the loading of the shared bus or the network and decreases the probability of data collision on the bus. Thus complicated design of arbitrators or routers may be avoided. The exemplary architecture also may ease the bandwidth requirement of the shared memory, and enhance the performance of pure SDR system while maintaining high area efficiency. FIG. 17 shows a manufacturing method for the universal modem system, according to an exemplary embodiment.

As seen in FIG. 17, the manufacturing method may configure a plurality of DSPs to perform at least one streaming-based task, or at least one block-based task, or both of the tasks (step 1710), connect at least one concatenate bus to at least one concatenate memory and the plurality of DSPs serially for performing the at least one streaming-based task (step 1720), configure at least one concatenate memory to store the data for the at least one streaming-based task (step 1730), and connect at least one public bus to the plurality of DSPs and at least one shared memory for performing the at least one block-based tasks (step 1740). The manufacturing method may further configure one or more L1 Copros to be in charge of one or more accelerating functions required by at least one DSP of the plurality of DSPs. The at least one DSP may cooperate with at least one L1 or L2 coprocessor, or both. The details of L1 or L2 coprocessor have been described, and omitted here. A protocol of interfacing the at least one DSP and the at least one coprocessor may follow the coprocessor interface protocol shown in FIG. 15, or as described in the earlier exemplary embodiments.

The method may further configure at least one coprocessor to be in charge of one or more accelerating functions required by at least one DSP of the plurality of DSPs, and may include a switch mechanism to assist said at least one DSP to cowork with the at least one coprocessor. The method may use the switch mechanism shown in FIG. 16, or as described in the earlier exemplary embodiments. Therefore, it may calculate one own wait cycle by a coprocessor that the at least one DSP wants to use. It may decides a switch flag for the coprocessor that the at least one DSP wants to use, by comparing its own wait cycle of the coprocessor with an individual threshold value. So that, the at least one DSP may decide whether or not to acquire the coprocessor according to a result of the comparison. Calculating one own wait cycle may depend on one or more parameters, and these parameters may be chosen from a group consisting of number of cycles taken for the coprocessor to finish a command, number of commands in the coprocessor waiting for processing, number of remaining cycles for a currently processing command, and number of coprocessor requests.

In summary of the disclosure, the above exemplary embodiments of the universal modem system and the manufacturing method may reduce the loading of the shared bus or the network and decrease the probability of data collision on the bus. Thus complicated design of arbitrators or routers may be avoided. The exemplary architecture also may ease the bandwidth requirement of the shared memory and enhance the performance of pure SDR system while maintaining high area efficiency. The exemplary embodiments of the coprocessors may be L1 coprocessors activated by DSPs or L2 coprocessors. Different DSPs may use the same or different L1 coprocessors, or even no L1 coprocessors. The L2 coprocessors may or may not exist in the system. The coprocessors may be implemented by hardware accelerating devices with or without one or more programmable functions. The exemplary embodiments of the disclosed switch mechanism may resolve the collision problem and increase the system performance.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A universal modem system, comprising:
a plurality of digital signal processors (DSPs) configured to perform at least one streaming-based task, or at least one block-based task, or both of said tasks;
at least one concatenate memory configured to store data for said at least one streaming-based task;
at least one concatenate bus connected to said at least one concatenate memory and said plurality of DSPs serially for performing said at least one streaming-based task;
at least one shared memory configured to store data for said at least one block-based task; and
at least one public bus connected to said plurality of DSPs and said at least one shared memory for performing said at least one block-based task.

2. The system as claimed in claim 1, wherein said at least one block-based task includes broadcasting, one or more feedback operations, passing the data needed on one or more non-adjacent elements coupled by said at least one concatenate bus, or one or more operations to be performed after a block of data is ready.

3. The system as claimed in claim 1, wherein said at least one streaming-based task includes one or more symbol by symbol operations performed by at least one processing element coupled by said at least one concatenate bus.

4. The system as claimed in claim 1, wherein said system further includes at least one coprocessor implemented by at least one hardware accelerating device with or without one or more programmable functions.

5. The system as claimed in claim 1, wherein said system further includes at least one coprocessor which is activated by at least one DSP of said plurality of DSPs and accesses said at least one concatenate memory directly.

6. The system as claimed in claim 5, wherein said system further includes a coprocessor interface, and said at least one coprocessor activated by said at least one DSP is in charge of one or more accelerating functions required by said plurality of DSPs via said coprocessor interface.

7. The system as claimed in claim 5, wherein said system further includes a switch mechanism to assist said plurality of DSPs to cowork with said at least one coprocessor activated by said at least one DSP.

8. The system as claimed in claim 7, wherein whether or not a DSP of said at least one DSP acquires one of said at least one coprocessor depends on a wait cycle and an individual threshold of the coprocessor.

9. The system as claimed in claim 5, wherein said system further includes a coprocessor interface protocol between said at least one coprocessor and said at least one DSP, and said coprocessor interface protocol includes at least one coprocessor request and at least one command from said at least one DSP, at least one coprocessor grant from a coprocessor interface, and at least one arbitration scheme in said coprocessor interface.

10. The system as claimed in claim 4, wherein said system further includes a switch mechanism to assist said plurality of DSPs to cowork with said at least one coprocessor.

11. The system as claimed in claim 10, wherein whether or not a DSP of said plurality of DSPs acquires one of said at least one coprocessor depends on a wait cycle and an individual threshold of the coprocessor.

12. The system as claimed in claim 1, wherein each of said at least one concatenate memory is configured as a shared region with at least one private region therein or without any private region therein.

13. A method for manufacturing a universal modem system, comprising:
configuring a plurality of DSPs to perform at least one streaming-based task, or at least one block-based task, or both of said tasks;
connecting at least one concatenate bus to at least one concatenate memory and said plurality of DSPs serially for performing the at least one streaming-based task;
configuring at least one concatenate memory to store data for said at least one streaming-based task; and
connecting at least one public bus to said plurality of DSPs and at least one shared memory for performing said at least one block-based task.

14. The method as claimed in claim 13, wherein said method further configures at least one coprocessor to be in charge of one or more accelerating functions required by at least one DSP of said plurality of DSPs, and said at least one coprocessor is activated by said at least one DSP and accesses said at least one concatenate memory directly.

15. The method as claimed in claim 14, wherein said method further includes a protocol of interfacing said at least one DSP and said at least one coprocessor.

16. The method as claimed in claim 15, wherein said protocol further includes:
asserting at least one coprocessor request by said at least one DSP, and holding said at least one coprocessor request and at least one command by said at least one DSP until one of said at least one coprocessor request is granted by a coprocessor interface; and
dispatching one of said at least one command of a granted DSP by said coprocessor interface to a corresponding coprocessor according to a coprocessor identifier.

17. The method as claimed in claim 13, wherein said method further configures at least one coprocessor to be in charge of one or more accelerating functions required by at least one DSP of said plurality of DSPs.

18. The method as claimed in claim 17, wherein said method further includes a switch mechanism to assist said at least one DSP to cowork with said at least one coprocessor.

19. The method as claimed in claim 18, wherein said switch mechanism further includes:
calculating one own wait cycle by a coprocessor that said at least one DSP wants to use;
comparing said wait cycle of the coprocessor that said at least one DSP wants to use with an individual threshold value; and
said at least one DSP deciding whether or not to acquire the coprocessor according to a result of the comparison.

20. The method as claimed in claim 18, wherein calculating said its own wait cycle depends on one or more parameters chosen from a group consisting of number of cycles taken for the coprocessor to finish a command, number of commands in the coprocessor waiting for processing, number of remaining cycles for a currently processing command, and number of coprocessor requests.

21. The method as claimed in claim 13, wherein said at least one public bus is connected to said plurality of DSPs and said at least one shared memory for performing broadcasting, one or more feedback operations, passing the data needed on one or more non-adjacent elements coupled by said at least one concatenate bus, or one or more operations to be performed after a block of data is ready.
